(19) United States
(12) Patent Application Publication
(10) Pub. No.: US 2002/0128334 A1
(43) Pub. Date: Sep. 12, 2002

(54) Heterogeneous ion exchange membrane and method of manufacturing thereof

(76) Inventors: Ian Glenn Towe, Caledon Village (CA); Mathew J. Yagar, Waterloo (CA); Guanghui Li, Guelph (CA)

Correspondence Address: ARNE I. FORS, GOWLING, STRATHY & HENDERSON, SUITE 4900, COMMERCE COURT WEST, TORONTO, ON, M5L 1J3, CA

(21) Appl. No.: 10/024,255

(22) Filed: Dec. 21, 2001

Related U.S. Application Data
(63) Continuation-in-part of application No. PCT/CA00/00741, filed on Jun. 21, 2000.

(30) Foreign Application Priority Data
Jun. 21, 1999 (CA) 2,275,999

(51) Int. Cl. C08J 5/20

(52) U.S. Cl. 521/27; 521/25

(57) ABSTRACT

A heterogeneous ion exchange material is provided which comprises an ion exchange resin incorporated within a binder, the binder comprising a material selected from the group consisting of: (i) a Metallocene catalyzed linear low density polyethylene, (ii) a very low density polyethylene or ultra low density polyethylene processed using either Ziegler-Natta catalysts or Metallocene catalysts, (iii) a thermoplastic elastomeric olefin comprising a polypropylene continuous phase with an ethylene-propylene-diene monomer or ethylene-propylene rubber rubbery phase dispersed through the polypropylene continuous phase, and (iv) a thermoplastic vulcanizate comprising a polypropylene continuous phase with an ethylene-propylene-diene monomer, ethylene-propylene rubber, nitrile-butadiene rubber, natural rubber or ethylene vinyl acetate rubbery phase dispersed through the polypropylene continuous phase. The ion exchange membrane can be manufactured using advanced extrusion techniques, including computer-controlled material fee, computer-controlled automatic die thickness adjustment with independently adjustable lip segments and nuclear gauge detection with feed-back control. It can also be manufactured by injection molding.

### FIELD OF INVENTION

The present invention relates to novel heterogeneous membranes, methods for producing such membranes, and apparatus employing such membranes.

### BACKGROUND OF THE INVENTION

Membranes that selectively allow diffusion and adsorption of ions while excluding certain other ions and non-ionized solutes and solvents, typically referred to as ion exchange membranes, have numerous important industrial applications. Such membranes are used in electrodialysis and electrodeionization equipment as well as in devices for fractionation, transport depletion and electro-regeneration, and purification or treatment of water, food, beverages, chemicals and waste streams. The membranes are also used in electrochemical devices such as caustic/chlorine electrolysis equipment, electropaint purification equipment, and electro-organic synthesis equipment. Additionally, ion exchange membranes are used in electrophoresis devices and analytical equipment as adsorbents, and as suppressor devices for ion chromatography. They are used in chemical treatment and concentration applications via the processes of Donnan dialysis and diffusion dialysis, and they are also used in batteries and fuel cells for the production of electricity.

In each of the applications described above, numerous membrane properties must be balanced against one another in order to achieve a membrane that satisfies the desired objectives of the particular application. Among these, it is an objective to employ ion exchange membranes that have high selectivity, low solvent and non-ionized solute transfer, low diffusion resistance of the ions selected, high physical strength, and good chemical resistance. Additionally, it is desirable that such membranes be easily manufactured at low cost without the use of hazardous substances. Furthermore, ideal membranes should be easy to handle and process and should also be amenable to low cost assembly techniques during the production of devices containing such membranes.

Current commercially available ion exchange membranes are primarily of two general types: homogeneous membranes and heterogeneous membranes. A homogeneous membrane is one in which the entire volume of the membrane (excluding any support material that may be used to improve strength) is made from the reactive polymer. Examples include membranes made of sulfonated or aminated styrene-divinylbenzene polymers (SDVB membranes), polymerized perfluorosulfonic acids (PFSO membranes) or various thermoplastics with active groups grafted onto the base polymer.

Unfortunately, homogeneous membranes tend to be difficult to manufacture. They also tend to employ the use of hazardous materials during their manufacturing process since, for the most part, they must be made from base monomers. Additionally, they are difficult to modify chemically because each modification requires a change in the fundamental chemistry of the membrane.

Homogeneous membranes also tend to have limited physical strength (therefore often requiring a screen or cloth support) because the polymer produced cannot readily combine both the required physical and electrochemical properties to operate efficiently in a fabricated device. Homogeneous membranes may be either crosslinked (to provide the membrane with dimensional stability, but increased brittleness and sensitivity upon drying), or they may be non-crosslinked (to provide membranes which may be dried, but lack dimensional stability and resistance to swelling and various solvents).

In contrast, heterogeneous membranes are formed of 1) a composite containing an ion exchange resin to impart electrochemical properties and 2) a binder to impart physical strength and integrity. Typical heterogeneous membranes maybe produced as “micro-heterogeneous” membranes by the paste method (in which ion exchange resin monomers are reacted to form the ultimate ion exchange resin polymer in the presence of a finely-ground inert binder polymer), or in the alternative, as “macro-heterogeneous” membranes by the physical blending of pre-polymerized ion exchange resin and binder.

Present macro-heterogeneous membranes tend to have inferior electrochemical properties as compared to micro-heterogeneous membranes, but they do offer a number of advantages as compared to membranes of the micro-heterogeneous variety. In particular, macro-heterogeneous membranes are easy to manufacture and can be readily chemically modified since, within limits, the binder and resin types and content can be varied without significantly modifying the manufacturing process. Notably, with micro-heterogeneous membranes, the binder must be compatible with the pre-cursor ion exchange monomers such that the binder does not interfere with the polymerization of the ion exchange monomer or, as a consequence of such polymerization, becomes chemically altered with undesirable properties.

In some filter-press type unit operations, ion exchange membranes are typically interposed between adjacent frame members to assist in defining individual chambers or compartments. For example, in filter-press type electrodeionization units, ion exchange membranes are interposed between adjacent frame members or spacers to form separate diluting and concentrating chambers. In assembling such units, a plurality of frame members are provided in a parallel manner with ion exchange membranes interposed between the frame members. The resulting structure is then forced together by clamping means with a view to providing a closed, tightly sealed unit.

Unfortunately, present ion exchange membrane materials do not possess entirely adequate sealing characteristics. During prolonged operation of the afore-mentioned unit operations, ion exchange membrane materials have a tendency to creep, thereby receding from contact with adjacent frame members and potentially compromising positive sealing of the unit. Present ion exchange membranes also tend to be brittle and prone to tearing or pinhole formation, thereby further potentially compromising the sealing of the unit.

In addition, present ion exchange materials are not particularly suitable for high temperature applications. As a result, unit operations having ion exchange membranes are unlikely candidates for pharmaceutical applications, where the constituent membranes would be exposed to high temperatures during cleaning for purposes of disinfection.

With respect to membrane manufacturing, the prior methods used to make heterogeneous ion exchange membranes involved standard equipment for sheet extrusion. This equipment is very common. However, extruding filled materials like heterogeneous ion exchange membranes involves special difficulties. Gauge control, gear pump pressure limits and uniformity of dispersion of the phases are all special difficulties encountered when extruding the materials in question. Yield rates as low as 30% are common.

### SUMMARY OF INVENTION

A heterogeneous ion exchange material is provided comprising an ion exchange resin incorporated within a binder, the binder comprising a material selected from the group consisting of (i) a polyolefin, copolymerized by single site catalyst technology, (ii) a very low density polyethylene or ultra low density polyethylene processed using either Ziegler-Natta catalysts or Metallocene catalysts, (iii) a thermoplastic elastomeric olefin comprising a polypropylene continuous phase with an ethylene-propylene-diene monomer or ethylene-propylene rubber rubbery phase dispersed through the polypropylene continuous phase, and (iv) a thermoplastic vulcanizate comprising a polypropylene continuous phase with an ethylene-propylene-diene monomer, ethylene-propylene rubber, nitrile-butadiene rubber, natural rubber, ethylene vinyl acetate rubbery phase dispersed through the polypropylene continuous phase, a co-polymer of vinylidene fluoride and hexafluoropropylene, or a co-polymer of vinylidene fluoride and hexafluoropropylene and tetrafluoroethylene.

In one aspect, the binder is a Metallocene catalyzed polyolefin..

In another aspect, the binder is a very low density polyethylene or ultra low density polyethylene processed using either Ziegler-Natta catalysts or Metallocene catalysts.

In a further aspect, the binder is a thermoplastic elastomeric olefin comprising a polypropylene continuous phase with an ethylene-propylene-diene monomer or ethylene-propylene rubber rubbery phase dispersed through the polypropylene continuous phase.

In yet a further aspect, the binder is a thermoplastic vulcanizate comprising a polypropylene continuous phase with an ethylene-propylene-diene monomer, ethylene-propylene rubber, nitrile-butadiene rubber, natural rubber or ethylene vinyl acetate rubbery phase dispersed through the polypropylene continuous phase.

A method for manufacturing an ion exchange membrane is also provided using advanced extrusion techniques, including computer-controlled material feed, computer-controlled automatic die thickness adjustment with independently adjustable lip segments and nuclear gauge detection with feed-back control. In one aspect, the method comprises the steps of: (i) extruding polymeric material through an auto-die, having a first lip block with a plurality of segments and a second lip block, at least one of the first lip block segments spaced from said second lip block, the at least one of the first lip block segments disposed at a first position, (ii) measuring a first thickness of the extruded polymeric material with a sensor, (iii) providing an input signal corresponding to the first thickness to a central processing unit (CPU), processing the input signal in said CPU by comparing said input signal to a setpoint corresponding to a desired thickness, (iv) providing an output signal, and (v) moving the at least one first lip block segment to a second position in response to said output signal to change the spacing between the at least one first lip block segment and the second lip block.

A method for manufacturing an ion exchange membrane is also provided by injection molding.

### BRIEF DESCRIPTION OF DRAWINGS

The present invention will be better understood with reference to the appended drawings in which:

FIG. 1 is an illustration of an auto-die;

FIG. 2 is a schematic of a method of manufacturing an ion exchange membrane.

### DETAILED DESCRIPTION

The composite membrane of the present invention maybe employed in various applications, including but not limited to, polarity-based chemical separations, such as electrodeionization and electrodialysis, electrolysis, fuel cells and batteries, pervaporation, gas separation, dialysis separation and industrial electrochemistry, such as chloralkali production and other electrochemical applications.

Heterogeneous ion exchange membranes are provided comprising typical ground ion exchange resin bound by a polymeric binder selected from: (i) a polyolefin, copolymerized by a single site catalyst technology, (ii) a very low density polyethylene (VLDPE) or ultra low density polyethylene (ULDPE) processed using either Ziegler-Natta catalysts or Metallocene catalysts, (iii) a thermoplastic elastomeric olefin comprising a polypropylene continuous phase with an ethylenepropylene-diene monomer (EPDM) or ethylene-propylene rubber (EPR) rubbery phase dispersed through the polypropylene continuous phase, and (iv) a thermoplastic vulcanizate comprising a polypropylene continuous phase with an EPDM, EBR, nitrile-butadiene rubber (NBR), natural rubber (NR), ethylene vinyl acetate (EVA) rubbery phase dispersed through the polypropylene continuous phase, a co-polymer of vinylidene fluoride and hexafluoropropylene, or a co-polymer of vinylidene fluoride and hexafluoropropylene and tetrafluoroethylene.

The polyolefin can be an ethylene alpha olefin copolymer, copolymerized using Metallocene catalysts or constrained geometry catalysts such as INSITE™ Technology. The thermoplastic vulcanizate can be AES SANTOPRENE™ or DSM SARLINK™, or AES TREFSIN™.

In one embodiment, the polyolefin is an alpha-olefin co-polymer, characterized by a crystallinity of less than 40%.. Suitable alpha-olefin co-monomers include C₄-C₁₂ alpha-olefins. In one embodiment, the alpha-olefin co-monomer is octene.

In another embodiment, the polyolefin is an ethylene alpha-olefin copolymer, copolymerized using single-site catalyst technology, such as a metallocene catalyst. An example of such suitable ethylene alpha-olefins are ENGAGETM polyolefin elastomers manufactured by DuPont Dow Elastomers.

In one embodiment, the ethylene alpha-olefin copolymer, copolymerized using single-site catalyst technology, is ethylene-octene copolymer. Octene content ranges from 16 to 40 wt %, Mooney viscosity is from 1.5 to 35, measured according to ASTM D1 646ML. Density is within the range of from 0.860 to 0.920 g/cm³. In another embodiment, the density is from 0.885 to 0.913 g/cm³. The melt index is from 0.5 to 30 dg/min, measured according to ASTM D-1238.

In one embodiment, the thermoplastic based elastomer is an alloy comprising a metallocene catalyzed polyolefin and any of polypropylene (PP), low density polyethylene (LDPE), high density polyethylene (HDPE), EDPM (cross-linked, partially cross-linked, or non-cross-linked), EPR (crosslinked, partially cross-linked, or non-cross-linked), EVA, or other synthetic rubbers such as a copolymer of vinylidene fluoride and hexafluoropropylene, or a co-polymer of vinylidene fluoride and hexafluoropropylene and tetrafluoroethylene.

In another embodiment, the thermoplastic based elastomer is an alloy of VLDPE or ULDPE and any of PP, LDPE, HDPE, metallocene catalyzed polyolefin, EPDM, (cross-linked, partially cross-linked, or non-cross-linked), EPR (cross-linked, partially cross-linked, or non-cross-linked) or EVA.

In another embodiment, the thermoplastic based elastomer is an alloy of (i) a thermoplastic elastomeric olefin comprising a polypropylene continuous phase with an EPDM or EPR rubbery phase dispersed through the polypropylene continuous phase, and (ii) any of LDPE, HDPE, metallocene catalyzed polyolefin, or linear low density polyethylene (LLDPE).

In another embodiment, the thermoplastic based elastomer is an alloy of (i) a thermoplastic vulcanizate comprising a polypropylene continuous phase with an EPDM EPR, NBR, NR or EVA rubbery phase dispersed through the polypropylene continuous phase, and (ii) any of LDPE, HDPE, metallocene catalyzed polyolefin, or linear low density polyethylene (LLDPE).

Suitable ion exchange resins include Rohm and Haas AMBERLITE™ IR120 and AMBERLITE™ IRA 402. Other suitable ion exchange resins include strongly basic anion and strongly basic cation resins with water content of less than 50 wt %, such as DIAION™ SA10A anion resin and DLAION™ SK1B cation resin manufactured by Mitsubishi Chemical Corporation. In another embodiment, the ion exchange resins are thermally stable and can be used to form high temperature ion exchange membranes which are configured to operate at temperatures >80° C. An example of a suitable high temperature anion exchange resin is DIAION™ TSA manufactured by Mitsubishi Chemical Corporation.

A heterogeneous ion exchange membrane can be manufactured using the binder polymers and ion exchange resins described above. The process includes resin drying, resin grinding, compounding of the ground resin and a binder polymer, and membrane sheeting.

IX resins have to be dried to lower their moisture content. Traditional ovens can be used to dry the resins. The heating temperatures are 60 to 120° C. and the drying times are 0.5 to 24 hours. A fluid bed dryer can be used continuously to dry the resins. The heating temperatures of a fluid be dryer are 60 to 120° C.

The dried resins need to be ground before used in mixing (compounding) process. A conventional turbo mill can be used to grind IX resins. The particle sizes of the ground resins are controlled. In one embodiment, the particle sizes are from 20 μm to 104 μm.

The water contents of the ground resins may need to be controlled during the grinding process. In one embodiment, the final ground resin water content should not be more than 6 wt %. If the water content of the ground resin is too high, an extra drying treatment may be required.

The ion exchange resin is combined with the above-described binder polymer. In one embodiment, the weight ratio of the ion exchange resin to binder polymer is from 30/70 to 70/30. In another embodiment, the ratio is from 50/50 to 60/40. A twin screw extruder or a mixer(kneader) is used in the compounding process in the present invention. The compounding temperatures are from 80° C. to 250° C., preferably from 120° C. to 220° C. The compound, comprising an ion exchange resin and a binder polymer, is pelletized. If a kneader is used in the compounding process, a conventional type pelletizer is required to pelletize the compound to pellets. In one embodiment, the water content of the pellets is less than 1 wt %. If the water content of pellets is more than 1 wt %, the pellets need to be dried to decrease them to less than 1 wt % before they are employed in the extrusion sheeting process.

The compound of the ion exchange resin and the binder polymer fabricated from the previous process is used in the sheeting process to manufacture the membrane of the present invention. Extrusion molding, injection molding, compression-injection molding processing techniques can be employed in the present invention to manufacture ion exchange membranes.

In one embodiment, the processing technique is sheeting extrusion by a single screw extruder. The extrusion temperature is from 80° C. to 250° C., preferably from 120 to 220° C. The final membrane thickness can be from 200 μm to 1000 82 m. In one embodiment, the membrane thickness is from 400 μm to 600 μm.

As an alternative to the compounding and sheeting processes, a twin screw extruder with a direct sheeting device can be used to manufacture the ion exchange membrane of the present invention.

The heterogeneous ion exchange membrane of the present invention can also be manufactured with advanced extrusion technology including computer controlled material feed, computer controlled automatic die thickness adjustment with independently adjustable lip segments and nuclear gauge detection with feed-back control. Alternatively, the heterogeneous ion exchange membrane of the present invention can be manufactured using injection molding.

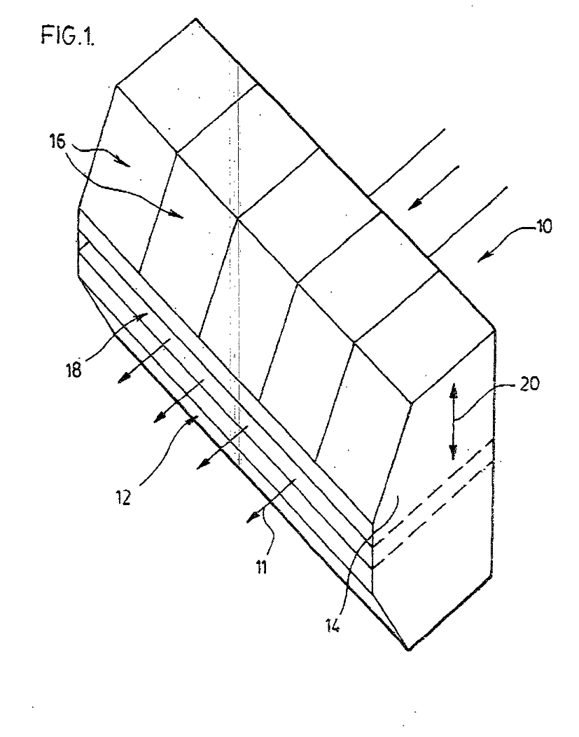

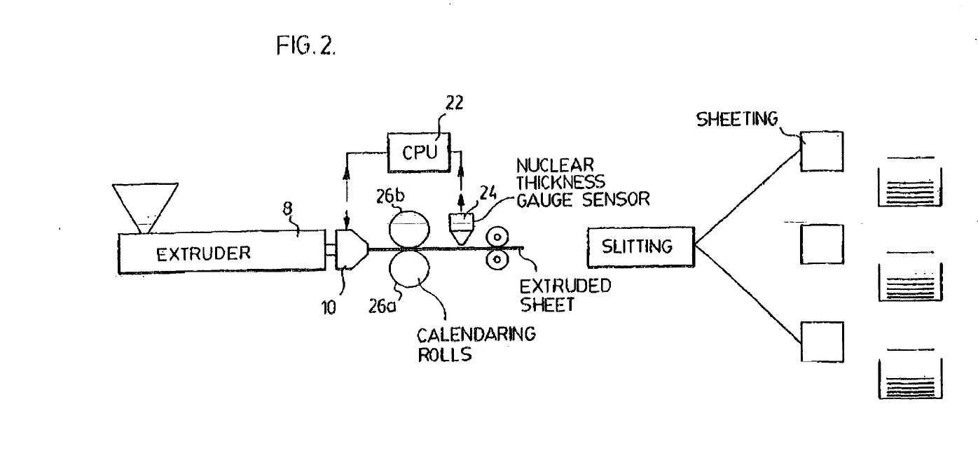

Referring to FIGS. 1 and 2, in one embodiment, the ion exchange membrane of the present invention is manufactured by advanced sheet extrusion technology to manufacture ion exchange membranes. The inventive process involves the use of very accurate nuclear gauge measuring instruments feeding back to a control computer that automatically adjusts an “auto-die” 10 (see FIG. 1). This auto-die has a first lip block 12 and a second lip block 14. The second lip block 14 is split into many individually adjustable segments or zones 16 for precise gauge control. Other extruder parameters and gear pump parameters can also be automatically adjusted.

Membrane ingredients, including the polymeric binder and the ion exchange resin, are fed by an extruder 8 into the auto-die 10 through gate slot 18 in the direction indicated by arrow 11. After exiting the autodie 10, the extruded material is fed through calendaring rolls 26a, 26b for flattening and solidifying the extruded sheet and smoothing its surface. Thickness of the extruded and calendared material is measured by a nuclear gauge sensor 24. At this time, the first lip block 12 is at a first position. The sensor provides an electrical input signal corresponding to the thickness of the extruded and calendared material to a central processing unit (CPU) 22. The CPU 22 compares the input signal with a set point corresponding to a desired thickness of the extruded and calendared material. The CPU 22 then provides an output signal to one or more of the zones 16 of the second lip block 14 of the auto-die 10. In response to this output signal, the zones 16 are actuated and move relative to the first lip block 12 from a first position to a second position in the direction indicated by arrows 20, thereby adjusting the spacing between the zone or zones 16 and the first lip block 12 and achieving the desired spacing.

A second embodiment of the invention involves the injection molding of ion exchange membranes. This reduces the production cost and further ensures dimensional consistency and adequate phase dispersion. Injection molding eases the processing of beneficial binder materials that may not be ideally suited to extrusion with a filler material such as ion exchange resin particles.

### EXAMPLE

ENGAGE 8403™ was used as a binder polymer. The octene content in the ethylene-octene copolymer was 16 wt %. ENGAGE 8403™ was characterized by the following physical properties: density was 0.913 g/cm³, the melt index was 30 dg/min, the surface hardness (Shore A) was 96, the ultimate tensile strength was 12.3 Mpa, and the DSC melting peak temperature was 107° C.

A strongly acidic cation exchange resin, DIAION SK-1B manufactured by Mitsubishi Chemical Corporation, was used. The resin was dried by a fluid bed dryer at 105° C. The water content of the dried resin was 3 wt %. This dried resin was ground to the powdery resin. The particles with particle sizes of from 104 to 150 μm were 0.8 wt %, the particles with particle sizes from 45 to 104 μm were 62 wt %, and particles with particle sizes smaller than 45 μm were 37.2 wt %. This powdery resin was mixed with ENGAGE 8403™ by a twin screw extruder in a weight ratio of 60/40. The extrusion temperature along the barrel varied from 165° C. proximate the feed to 197° C. at the die. The extradite was pelletized to form 2 mm diameter pellets. The water content of the pellets was measured to be 0.5 wt %. The pellets were used directly in the extrusion sheeting process. A single screw extruder was used for the extrusion sheeting process. The extrusion temperature varied along the barrel from 130° C. proximate the feed to 132° C. at the die. The final membrane thickness was 500±10 μm.

The final membrane was conditioned in 0.5N sodium chloride aqueous solution at 40° C. for 1 days. The electrical resistance of the conditioned membrane was measured at an alternate current of 1,000 Hz in a 0.5N sodium chloride aqueous solution. The resistance was 457 Ω.cm. The transport number of the conditioned membrane was also measured between 0.5N and 1.0N sodium chloride aqueous solutions. The transport number was 0.872. The mechanical properties were tested by an Instron 4467 Universal Testing System. The tensile strength at yield was 2.5 MPa and the percent elongation was 138%.

It will be understood, of course, that modification can be made in the embodiments of the invention described herein without departing from the scope and purview of the invention as defined by the appended claims.

We claim:

1. A heterogeneous ion exchange material which comprises an ion exchange resin incorporated within a binder, the binder comprising a material selected from the group consisting of (i) a polyolefin copolymerized by a single site catalyst technology, (ii) a very low density polyethylene or ultra low density polyethylene processed using either Ziegler-Natta catalysts or Metallocene catalysts, (iii) a thermoplastic elastomeric olefin comprising a polypropylene continuous phase with an ethylene-propylene-diene monomer or ethylene-propylene rubber rubbery phase dispersed through the polypropylene continuous phase, and (iv) a thermoplastic vulcanizate comprising a polypropylene continuous phase with an ethylenepropylene-diene monomer, ethylene-propylene rubber, nitrile-butadiene rubber, natural rubber, ethylene vinyl acetate rubbery phase dispersed through the polypropylene continuous phase, a co-polymer of vinylidene fluoride and hexafluoropropylene, or a co-polymer of vinylidene fluoride and hexafluoropropylene and tetrafluoroethylene.

2. The heterogeneous ion exchange material of claim 1 wherein the binder is a metallocene catalyzed polyolefin.

3. The heterogeneous ion exchange membrane of claim 2, wherein the binder is a an alpha-olefin co-polymer.

4. The heterogeneous ion exchange membrane of claim 3, wherein the binder is an ethylene alpha-olefin co-polymer.

5. The heterogeneous ion exchange membrane of claim 4, wherein the binder is an ethylene octene co-polymer.

6. The heterogeneous ion exchange membrane of claim 3, wherein the binder is characterized by a crystallinity of less than 40%.

7. The heterogeneous ion exchange material of claim 1 wherein the binder is a very low density polyethylene or ultra low density polyethylene processed using either Ziegler-Natta catalysts or Metallocene catalysts.

8. The heterogeneous ion exchange material of claim 1 wherein the binder is a thermoplastic elastomeric olefin comprising a polypropylene continuous phase with an ethylene-propylene-diene monomer or ethylene-propylene rubber rubbery phase dispersed through the polypropylene continuous phase.

9. The heterogeneous ion exchange material of claim 1 wherein the binder is a thermoplastic vulcanizate comprising a polypropylene continuous phase with an ethylene-propylene-diene monomer, ethylene-propylene rubber, nitrile-butadiene rubber, natural rubber, ethylene vinyl acetate rubbery phase dispersed through the polypropylene continuous phase, a co-polymer of vinylidene fluoride and hexafluoropropylene, or a co-polymer of vinylidene fluoride and hexafluoropropylene and tetrafluoroethylene.

10. A method for manufacturing an ion exchange membrane using advanced extrusion techniques, including computer-controlled material feed, computer-controlled automatic die thickness adjustment with independently adjustable lip segments and nuclear gauge detection with feed-back control.

11. A method for manufacturing an ion exchange membrane using advanced extrusion techniques, comprising the steps of:
extruding polymeric material through an auto-die, having a first lip block with a plurality of segments and a second lip block, at least one of said first lip block segments spaced from said second lip block, said at least one of said first lip block segments disposed at a first position;
measuring a first thickness of the extruded polymeric material with a sensor;
providing an input signal corresponding to said first thickness to a CPU;
processing said input signal in said CPU by comparing said input signal to a setpoint corresponding to a desired thickness;
providing an output signal; and
moving said at least one first lip block segment to a second position in response to said output signal to change the spacing between said at least one first lip block segment and said second lip block.

12. A method for manufacturing an ion exchange membrane using injection molding.
